(19) United States
(12) Patent Application Publication
(10) Pub. No.: US 2013/0043764 A1
(43) Pub. Date: Feb. 21, 2013

(54) ULTRASONIC SENSOR

(71) Applicants: Boum Seock Kim, Gyeonggi-do (KR); Sung Kwon Wi, Seoul (KR); Eun Tae Park, Gyeonggi-do (KR)

(72) Inventors: Boum Seock Kim, Gyeonggi-do (KR); Sung Kwon Wi, Seoul (KR); Eun Tae Park, Gyeonggi-do (KR)

(73) Assignee: Samsung Electro-Mechanics Co., Ltd., Suwon (KR)

(21) Appl. No.: 13/568,635

(22) Filed: Aug. 7, 2012

(30) Foreign Application Priority Data
Aug. 19, 2011 (KR) 10-2011-0082908

(51) Int. Cl. G01H 11/08

(52) U.S. Cl. 310/315

(57) ABSTRACT

Disclosed herein is an ultrasonic sensor including: a conductive case; a piezoelectric element fixed to a bottom surface of the case through a conductive adhesive; a temperature compensation capacitor positioned on the piezoelectric element; a first lead wire and electrically connected to one surface of the temperature compensation capacitor; a first wire electrically connecting one surface of the temperature compensation capacitor and the case to each other; a second lead wire and electrically connected to the other surface of the temperature compensation capacitor; a second wire electrically connecting the other surface of the temperature compensation capacitor and an upper surface of the piezoelectric element to each other; and a fixing part fixing the first lead wire and the first wire to one surface of the temperature compensation capacitor and fixing the second lead wire and the second wire to the other surface thereof.

### CROSS REFERENCE(S) TO RELATED APPLICATIONS

This application claims the benefit under 35 U.S.C. Section 119 of Korean Patent Application Serial No. 10-2011-0082908, entitled “Ultrasonic Sensor” filed on Aug. 19, 2010, which is hereby incorporated by reference in its entirety into this application.

### BACKGROUND OF THE INVENTION

1. Technical Field

The present invention relates to a sensor, and more particularly, to an ultrasonic sensor capable of measuring a distance to an object to be measured by generating an ultrasonic wave using a piezoelectric element and sensing a time required for the generated ultrasonic wave to be returned by being reflected from the objected to be measured.

2. Description of the Related Art

As an ultrasonic sensor, there two kinds of ultrasonic sensors, that is, a piezoelectricity type ultrasonic sensor and a magnetostriction type ultrasonic sensor have been generally used. The piezoelectricity type ultrasonic sensor uses a phenomenon in which when pressure is applied to an object such as a crystal, a PZT (a piezoelectric material), a piezoelectric polymer, and the like, voltage is generated, and when voltage is applied thereto, vibration is generated. The magnetostriction type ultrasonic sensor uses a Joule effect (a phenomenon in which when a magnetic field is applied, vibration is generated) and a Villari effect (a phenomenon in which when stress is applied, a magnetic field is generated) generated in an alloy of iron, nickel, and cobalt, etc.

An ultrasonic element may be an ultrasonic generator simultaneously with being an ultrasonic sensor. The reason is that the piezoelectricity type ultrasonic sensor senses an ultrasonic wave by voltage generated by applying ultrasonic vibration to a piezoelectric element and generates an ultrasonic wave by vibration generated by applying voltage to the piezoelectric element. In addition, the reason is that the magnetostriction type ultrasonic sensor generates an ultrasonic wave by the Joule effect and senses an ultrasonic wave by the Villari effect.

A piezoelectricity type of ultrasonic sensor using a piezoelectric element has currently been generally used. The piezoelectricity type of ultrasonic sensor has a structure in which the piezoelectric element is seated in a case and an ultrasonic wave generated in the piezoelectric element is discharged to the outside through the case.

In addition, since the piezoelectric element has sensitivity changed according to an external temperature, a temperature compensation capacitor for compensating for the change in sensitivity is positioned in the case, and a substrate for fixing the temperature compensation capacitor is also mounted in the case. The substrate also serves as a terminal of a wire connecting the piezoelectric element, the temperature compensation capacitor, and the like, to each other.

In addition, a sound absorbing material absorbing vibration energy of the piezoelectric element to thereby reduce a reverberation time and protect internal components is positioned in the case. As the sound absorbing material, non-woven fabric is used.

The ultrasonic sensor as described above includes various components positioned therein and electrically connected to each other through a wire and a substrate. However, it is difficult to fix these components before being inserted into the case, and the substrate and the temperature compensation capacitor are positioned at positions at which they may not be easily handled in a device, thereby having a difficulty in mass production and automatic production. Due to these problems, the ultrasonic sensors have been mainly produced manually.

### SUMMARY OF THE INVENTION

An object of the present invention is to provide an ultrasonic sensor in which a substrate for fixing a temperature compensation capacitor is not required and lead wires and wires are electrically connected simply to the temperature compensation capacitor, thereby facilitating automatic production and mass production.

According to an exemplary embodiment of the present invention, there is provided an ultrasonic sensor including: a conductive case; a piezoelectric element fixed to a bottom surface of the case through a conductive adhesive; a temperature compensation capacitor positioned on the piezoelectric element; a first lead wire led from the outside of the case and electrically connected to one surface of the temperature compensation capacitor; a first wire electrically connecting one surface of the temperature compensation capacitor and the case to each other; a second lead wire led from the outside of the case and electrically connected to the other surface of the temperature compensation capacitor; a second wire electrically connecting the other surface of the temperature compensation capacitor and an upper surface of the piezoelectric element to each other; and a fixing part fixing the first lead wire and the first wire to one surface of the temperature compensation capacitor and fixing the second lead wire and the second wire to the other surface thereof.

The fixing part may have a clip shape in which it compresses one surface and the other surface of the temperature compensation capacitor.

The fixing part may be made of a non-conductive material.

The fixing part may be coated with a non-conductive material.

The ultrasonic sensor may further include a sound absorbing material positioned on the piezoelectric element.

The ultrasonic sensor may further include a molding part filled in the case.

### BRIEF DESCRIPTION OF THE DRAWINGS

FIG. 1 is a perspective view of an ultrasonic sensor according to an exemplary embodiment of the present invention;

FIG. 2 is a perspective view showing an inner portion of the ultrasonic sensor shown in FIG. 1;

FIG. 3 is a perspective view showing a fixing part shown in FIG. 2; and

FIG. 4 is a cross-sectional view taken along line I-I′ of FIG. 3.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

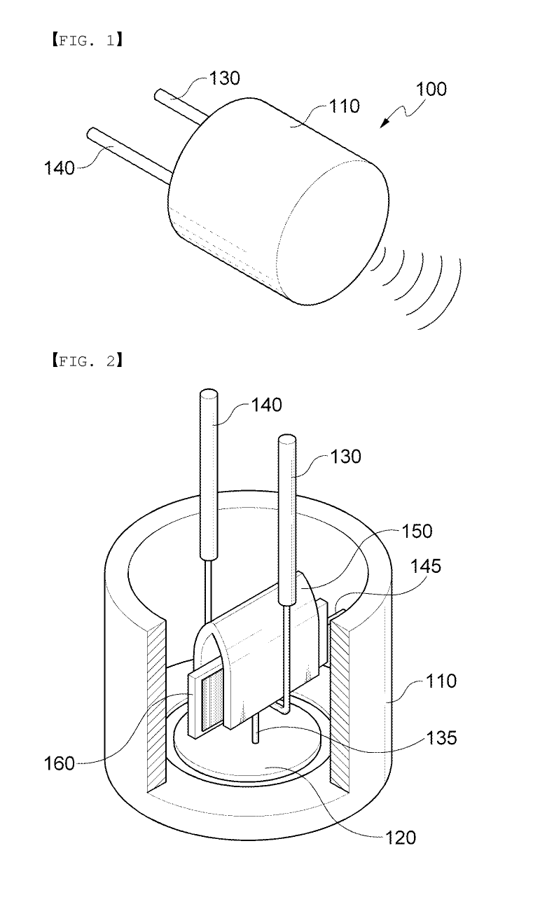

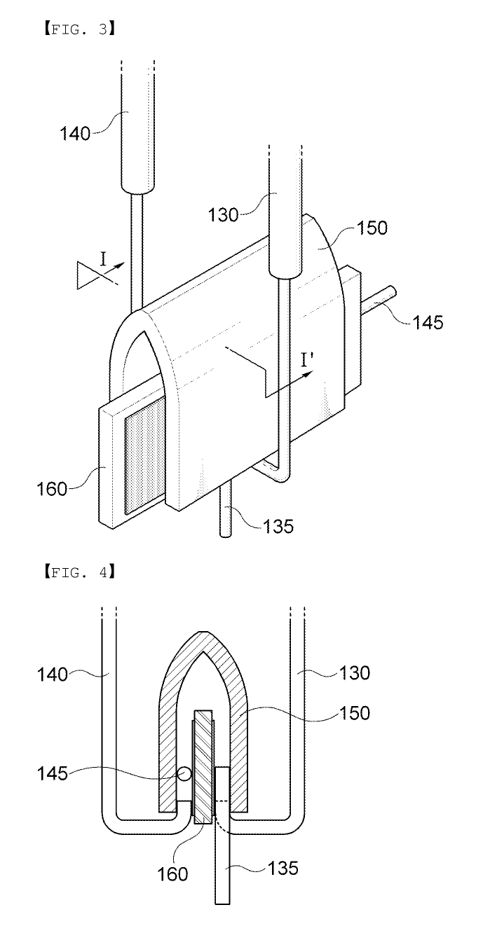

FIG. 1 is a perspective view of an ultrasonic sensor according to an exemplary embodiment of the present invention; FIG. 2 is a perspective view showing an inner portion of the ultrasonic sensor shown in FIG. 1; FIG. 3 is a perspective view showing a fixing part shown in FIG. 2; and FIG. 4 is a cross-sectional view taken along line I-I′ of FIG. 3. Referring to FIGS. 1 and 4, the ultrasonic sensor 100 according to the exemplary embodiment of the present invention includes a case 110, a piezoelectric element 120, a first lead wire 130, a first wire 135, a second lead wire 140, a second wire 145, a fixing part 150, and a temperature compensation capacitor 160.

The case 110 is made of a conductive material and includes a space formed therein, wherein the space may receive components therein. The piezoelectric element 120 serves to generate an ultrasonic wave and is fixed to a bottom surface of the case 110 through a conductive adhesive.

The piezoelectric element 120, which is a component displaced when a current is applied thereto, is extended or contracted according to the polarity of the applied current. Therefore, when the polarity of the current applied to the piezoelectric element 120 is repeatedly changed, the piezoelectric element 120 generates vibration while being repeatedly extended and contracted. An ultrasonic wave is generated from the piezoelectric element 120 through this principle.

Meanwhile, the piezoelectric element 120 has a property in which a capacitance value thereof is changed according to a temperature. Due to this property, reverberation vibration of the piezoelectric element 120 is increased at a low temperature, such that a malfunction of a system is generated, and sensitivity of the piezoelectric element 120 is deteriorated at a high temperature, such that a sensing distance is reduced. In order to prevent this phenomenon, a change in the capacitance value of the piezoelectric element 120 is compensated for by using the temperature compensation capacitor 160.

The first lead wire 130 is led from the outside of the case 110 and is electrically connected to one surface of the temperature compensation capacitor 160. In addition, the first wire 135 electrically connects one surface of the temperature compensation capacitor 160 and the case 110 to each other.

Further, the second lead wire 140 is led from the outside of the case 110 and is electrically connected to the other surface of the temperature compensation capacitor 160. In addition, the second wire 145 electrically connects the other surface of the temperature compensation capacitor 160 and an upper surface of the piezoelectric element 120 to each other.

Meanwhile, since the case 110 is electrically connected to a lower surface of the piezoelectric element 120 through the conductive adhesive, the second lead wire 140 is connected to the lower surface of the piezoelectric element 120 through the second wire 145 and the case 110.

In addition, the fixing part 150 fixes the first lead wire 130 and the first wire 135 to one surface of the temperature compensation capacitor 160 and fixes the second lead wire 140 and the second wire 145 to the other surface thereof.

Here, the fixing part 150 may have a clip shape in which it compresses one surface and the other surface of the temperature compensation capacitor 160. Through the fixing part 150 having the clip shape, the first and second lead wire 130 and 140 and the first and second wires 135 and 145 may be engaged with and fixed to the temperature compensation capacitor 160 at a time and the respective components also may be electrically connected to each other.

Therefore, in the ultrasonic sensor 100 according to the exemplary embodiment of the present invention, a separate substrate fixing the temperature compensation capacitor 160 and serving as a terminal is not required, and the lead wires 130 and 140 and the wires 135 and 145 may be simply connected/fixed to the temperature compensation capacitor 160 through the above-mentioned fixing part 150. Therefore, the ultrasonic sensor 100 according to the exemplary embodiment of the present invention may be mass-produced through automation instead of the existing manual work.

Meanwhile, the fixing part 150 may be made of a non-conductive material. The reason is that since the first and second lead wires 130 and 140 are fixed to the temperature compensation capacitor 160 in a form in which they are engaged with each other, having the temperature compensation capacitor 160 therebetween, in the fixing part 150 having the clip shape, they are connected to each other through the fixing part 150, such that they may be short-circuited.

In addition, the fixing part 150 may be coated with a non-conductive material. When the fixing part 150 is made of a conductive material, the fixing part 150 is coated with the non-conductive material, thereby making it possible to prevent a short-circuit between the first and second lead wires 130 and 140.

In addition, the ultrasonic sensor 100 according to the exemplary embodiment of the present invention may further include a sound absorbing material (not shown) positioned on the piezoelectric element 120. This sound absorbing material reduces reverberation which appears after the ultrasonic wave is generated in the piezoelectric element 120.

The piezoelectric element 120 serves to not only generate the ultrasonic wave but also sense an ultrasonic wave returned by being reflected from an objected to be measured. The piezoelectric element 120 may sense the reflected ultrasonic wave only when the reverberation that appears after the ultrasonic wave is generated completely disappears.

Therefore, when the reverberation of the piezoelectric element 120 is continued for a long time, it takes a long time to sense the ultrasonic wave, such that it takes a long time for the ultrasonic sensor 100 to sense a distance.

The sound absorbing material (not shown) serves to reduce the reverberation generated in the piezoelectric element 120 to thereby reduce the sensing time of the ultrasonic sensor 100.

In addition, the ultrasonic sensor 100 according to the exemplary embodiment of the present invention may further include a molding part (not shown). The molding part (not shown), which is formed by injecting a molding liquid into the case 110 and curing the molding liquid, serves to fix, seal, and protect components positioned in the case 110.

With the ultrasonic sensor according to the exemplary embodiment of the present invention, a separate substrate for fixing the temperature compensation capacitor is not required and a manufacturing process is simplified, thereby making it possible to perform mass production through automation.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An ultrasonic sensor comprising:
a conductive case;
a piezoelectric element fixed to a bottom surface of the case through a conductive adhesive;
a temperature compensation capacitor positioned on the piezoelectric element;
a first lead wire led from the outside of the case and electrically connected to one surface of the temperature compensation capacitor;
a first wire electrically connecting one surface of the temperature compensation capacitor and the case to each other;
a second lead wire led from the outside of the case and electrically connected to the other surface of the temperature compensation capacitor;
a second wire electrically connecting the other surface of the temperature compensation capacitor and an upper surface of the piezoelectric element to each other; and
a fixing part fixing the first lead wire and the first wire to one surface of the temperature compensation capacitor and fixing the second lead wire and the second wire to the other surface thereof.

2. The ultrasonic sensor according to claim 1, wherein the fixing part has a clip shape in which it compresses one surface and the other surface of the temperature compensation capacitor.

3. The ultrasonic sensor according to claim 2, wherein the fixing part is made of a non-conductive material.

4. The ultrasonic sensor according to claim 2, wherein the fixing part is coated with a non-conductive material.

5. The ultrasonic sensor according to claim 1, further comprising a sound absorbing material positioned on the piezoelectric element.

6. The ultrasonic sensor according to claim 1, further comprising a molding part filled in the case.
